(19) United States
(12) Patent Application Publication
(10) Pub. No.: US 2026/0169985 A1
(43) Pub. Date: Jun. 18, 2026

(54) GENERATIVE ARTIFICIAL INTELLIGENCE SYSTEMS AND METHODS WITH LINGUISTIC INTUITIVE MANUAL PROMPTING TECHNIQUES

(71) Applicant: Levi C. Hatter, Bay City, MI (US)

(72) Inventor: Levi C. Hatter, Bay City, MI (US)

(21) Appl. No.: 19/415,934

(22) Filed: Dec. 11, 2025

Related U.S. Application Data
(60) Provisional application No. 63/733,624, filed on Dec. 13, 2024.

(51) Int. Cl. G06F 16/2453; G06F 16/2452

(52) U.S. Cl. CPC G06F 16/24542; G06F 16/24522

(57) ABSTRACT

Presented are generative artificial intelligence (AI) systems with linguistic intuitive manual prompting techniques for enhanced content creation, methods for training/using such systems, and computer-readable code for operating such generative AI systems. A generative AI system includes a Linguistic Intuitive Manual Prompting (LIMP) component that contains predefined sets of linguistic guidelines and structural guidelines by which users interact with the generative AI system. The LIMP component contains multiple language processing modules that are individually activatable by a user. Connected to the LIMP component is a Master Modular Quill (MMQ) component that reformats the LIMP's language processing modules into a predefined functional format that enables user customization of the reformatted modules. Also connected to the LIMP component is a Modular Enhancement Guide (MEG) component that actively monitors for regulatory changes and/or user feedback to automatically update one or more of the MMQ's reformatted language processing modules based on the regulatory changes/user feedback.

### CLAIM OF PRIORITY AND CROSS-REFERENCE TO RELATED APPLICATION

This application claims the benefit of and priority to U.S. Provisional Patent Application No. 63/733,624, which was filed on Dec. 13, 2024, and is incorporated herein by reference in its entirety and for all purposes.

### INTRODUCTION

The present disclosure relates generally to artificial intelligence-driven computational systems. More specifically, aspects of this disclosure relate to trained large language model frameworks for natural language processing and content generation.

Generative artificial intelligence (AI) is a term that may be used to designate an AI system whose primary function is to generate content, such as translating speech from a natural (origin) form to a designated (target) form or for producing text-based responses to text-based inputs of a user. This contrasts with other AI models that perform different functions, such as classifying data (e.g., evaluating and labelling digital images), grouping data (e.g., processing and identifying data segments with similar behaviors), or determining actions (e.g., governing dynamic operation of a machine). Some non-limiting examples of generative AI computer systems include image generators, large language models, code generation tools, and audio generation tools. A large language model (LLM) is a type of generative AI system that is trained through self-supervised machine learning to use natural language inputs for deriving language-based outputs. Over the past several years, language model research has shown that using more data and computational power to train models with more parameters consistently results in better system performance, hence the qualifier “large” over traditional trained language models.

Current AI reasoning and conversational systems typically depend on static prompts or isolated memory mechanisms to generate desired responses, which may result in inconsistent system performance and limited response personalization. These systems lack a persistent yet privacy-safe representation of user or organizational identity that can shape reasoning style, tone, and retrieval behavior across sessions and domains. Existing personalization methods, such as preference tags or user profiles, are limited to superficial output modifications and, thus, do not extend into reasoning orchestration or retrieval-augmented generation (RAG) workflows. Consequently, many AI system-generated outputs remain inconsistent in tone, depth, and domain alignment. Prior reasoning frameworks, including Modular Reasoning, Knowledge, and Language (MRKL) and Mixture of Cognitive Reasoners (MiCRo), provide multi-module reasoning coordination but do not implement adaptive personalization or identity-based modulation of reasoning behavior. These identity frameworks are unable to: (1) express cognitive, behavioral, and linguistic parameters in a machine-readable form; (2) bind those parameters to prompt construction and reasoning orchestration; and (3) govern retrieval, ranking, and validation in a manner consistent with identity characteristics without exposing personally identifiable information or relying on proprietary vendor infrastructure.

### SUMMARY

Presented below are generative AI computational systems with embedded linguistic intuitive manual prompting techniques for enhanced content creation, methods for training and methods for operating such generative AI systems, and memory-stored, computer-readable code for provisioning such generative-AI computational techniques. By way of non-limiting example, a trained LLM framework includes a Linguistic Intuitive Manual Prompting (LIMP) component with a Master Modular Quill (MMQ) component and a Modular Enhancement Guide (MEG) component that collectively provide, for example, a structured approach to complex documentation for the collaborative cocreation of content. This construct may offer an adaptive design with enhanced user interactions for integration with large language models across various sectors. In addition, disclosed LLM frameworks may provide a unique solution to the innate challenges of effective language model prompting to help address accessibility, user autonomy, and adaptability. The MMQ and MEG components may each provide a distinct role in structuring user prompts and enabling real-time customization for regulatory and contextual demands.

A generative AI system is presented that includes a Linguistic Intuitive Manual Prompting component, which contains a predefined set of linguistic guidelines and a predefined set of structural guidelines by which users interact with the generative AI system. The LIMP component contains multiple language processing modules that are individually activatable by a user. Connected to the LIMP component is a Master Modular Quill component that reformats the LIMP's language processing modules into a predefined functional format that enables user customization of the reformatted language processing modules. Also connected to the LIMP component is a Modular Enhancement Guide component that actively monitors for regulatory changes and/or user feedback and automatically updates one or more of the reformatted language processing modules based on the regulatory changes/user feedback.

Disclosed systems and methods may help to systematically improve modular artificial-intelligence reasoning using a multistage pipeline that contains the LIMP module, the MMQ orchestration module, and the MEG refinement engine. For instance, a natural-language input may be segmented into structured prompt components by the LIMP module. These prompt components may then be assembled into a modular reasoning pathway by the MMQ orchestration module, which selects and arranges reasoning steps from a library of predefined modular operations. The MEG refinement engine recursively evaluates the MMQ's intermediate results and refines the reasoning pathway until a stability criterion is reached. In so doing, the multistage pipeline system may help to improve determinism, reduce variance in model output, and produce structured composite prompts for language-model execution. Other attendant benefits may include providing a streamlined and high-efficiency layered architecture that separates core execution, intelligence orchestration, and data-access mechanisms.

Disclosed methods and systems may provision structured and modular AI reasoning workflows that employ a deterministic, multi-module pipeline that decomposes complex prompts into modular reasoning components. Unlike traditional language-model systems, which often rely on single-pass inference prompt processing, the multi-module pipeline system may produce more consistent outcomes due to structured prompt formatting, unambiguous user intent, and refineability. The LIMP module may receive natural-language inputs and perform segmentation, classification, and linguistic normalization to convert the inputs into structured prompt elements. The MMQ module may orchestrate a reasoning pathway by selecting modular operations, which may be combined into a structured plan, and concomitantly determine an order for executing the reasoning steps. The MEG module may apply recursive refinement, evaluate intermediate outputs, adjust the pathway, and terminate when stability or convergence criteria are met. An Execution Layer may output a final structured reasoning plan to a language-model inference engine. Attendant advantages may include improved reasoning consistency, reduced output variance, repeatable and auditable reasoning pathways, flexible integration with external tools, retrieval modules, and data sources, and compatibility with layered architectures and modular AI platforms. Disclosed features are not per se limited to a particular machine-learning framework and may be used with any large language model, retrieval-augmented system, or orchestration engine.

Aspects of this disclosure are directed to system control logic and closed-loop feedback control techniques for structured and modular artificial-intelligence reasoning workflows. In an example, a method is presented for operating a generative AI system. This representative method includes, in any order and in any combination with any of the above and below disclosed options and features: receiving, e.g., via a user interface layer of the generative AI system from a computing device of a user, a text-based user input containing a natural language prompt; preprocessing, e.g., via a Linguistic Intuitive Manual Prompting component within an intelligence pipeline layer connected to the user interface layer, the text-based user input to transform the natural language prompt to a set of structured prompt components; selecting, e.g., via a Master Modular Quill component within the intelligence pipeline layer from a library of predefined modular operations, a set of modular reasoning operations for a desired task associated with the natural language prompt; mapping, e.g., via the MMQ component, the set of structured prompt components to the set of modular reasoning operations to generate a set of reasoning steps; performing, e.g., via a Modular Enhancement Guide component, recursive refinement of the set of reasoning steps to generate a refined reasoning plan; generating, e.g., via the MMQ component using the refined reasoning plan, a composite prompt containing a set of structured instructions with associated system parameters; and executing, e.g., via a large-language model, the set of structured instructions with associated system parameters within the composite prompt to generate an (initial/intermediate/final) LLM output.

Aspects of this disclosure are also directed to computer-readable media (CRM) containing controller-executable instructions for enabling embedded linguistic intuitive manual prompting techniques for enhanced content creation. In an example, a non-transient, physical CRM stores instructions that are executable by one or more processors of a system controller of a generative AI system. These CRM-stored instructions, when executed by the controller processor(s), cause the system to perform operations that include: receiving, via a user interface layer of the generative AI system from a computing device of a user, a text-based user input containing a natural language prompt; preprocessing, via a LIMP component within an intelligence pipeline layer connected to the user interface layer, the text-based user input to transform the natural language prompt to a set of structured prompt components; selecting, via an MMQ component within the intelligence pipeline layer of the generative AI system from a library of predefined modular operations, a set of modular reasoning operations for a desired task associated with the natural language prompt; mapping, via the MMQ component, the set of structured prompt components to the set of modular reasoning operations to generate a set of reasoning steps; performing, via a MEG component within the intelligence pipeline layer, recursive refinement of the set of reasoning steps to generate a refined reasoning plan; generating, via the MMQ component using the refined reasoning plan, a composite prompt containing a set of structured instructions with associated system parameters; and executing, via an LLM, the set of structured instructions with associated system parameters within the composite prompt to generate an LLM output.

Additional aspects of this disclosure are directed to multimodal, supervised machine learning (ML) LLMs with structured and modular AI-reasoning workflows. In an example, a generative AI system includes a user interface layer, which communicates with a user's computing device to receive therefrom a text-based user input that contains a natural language prompt, and an intelligence pipeline layer, which is communicatively connected to the user interface layer. The intelligence pipeline layer includes three interoperable components: a LIMP component, an MMQ component, and a MEG component. The LIMP component preprocesses text-based user inputs to transform the natural language prompts within these inputs to structured prompt components. In tandem, the MMQ component connects to a library of predefined modular operations and selects therefrom a set of modular reasoning operations for a desired task associated with a natural language prompt. The MMQ component then maps the structured prompt components output by LIMP to the modular reasoning operations to generate a set of reasoning steps.

Continuing with the foregoing example, the MEG component performs recursive refinement of the reasoning steps output by the MMQ component to generate a refined reasoning plan. Using the refined reasoning plan, the MMQ component concomitantly generates a composite prompt that contains a set of structured instructions along with associated system parameters. The composite prompt is output through a suitable interface/API connector to a large-language model; the LLM executes the set of structured instructions with associated system parameters within the composite prompt to generate an LLM output.

For any of the disclosed systems, methods, and CRM, the MMQ component may sequence the reasoning steps to generate a sequenced set of reasoning steps prior to the MEG component performing the recursive refinement of the reasoning steps. In this instance, the MMQ component may also validate the sequenced set of reasoning steps to remove therefrom any redundant or contradictory steps. Validating the sequenced set of reasoning steps may include checking ordering constraints, ensure dependencies are satisfied, and verify completeness of the reasoning plan. As a further option, the library of predefined modular operations may include an input types module, an output types module, a dependencies module, a constraints module, and an associated template module.

For any of the disclosed systems, methods, and CRM, the generative AI system architecture may contain a Data & Knowledge (D&K) layer that is connected to and operatively interposed between the intelligence pipeline layer and the recipient LLM. This D&K layer may execute a vector database (DB) search to retrieve informational context data for the set of reasoning steps based on associated relevance and semantic criteria. In this instance, executing the vector database search may include performing a task-based semantic weighting for each step in the set of reasoning steps. The task-based semantic weighting may be weighted based on a semantic similarity to extracted subtask weight, a document relevance weight, a domain filtering weight, and/or a task-priority criteria weight. As a further option, retrieving the informational context data may include semantic matching, relevance scoring, and/or domain filtering.

For any of the disclosed systems, methods, and CRM, preprocessing the text-based user input may include tokenization, segmentation, and clause decomposition of the natural language prompt. In this instance, preprocessing the text-based user input may also include intent detection, subtask extraction, and linguistic normalization of the natural language prompt. As a further option, the LIMP component may also refine a linguistic clarity of the LLM output executed by the LLM to generate a refined LLM output. In this instance, the MMQ component may validate the refined LLM output to the refined reasoning plan to generate a final LLM output.

The above summary does not represent every embodiment or every aspect of the present disclosure. Rather, the foregoing summary merely provides a synopsis of some of the novel concepts and features set forth herein. The above features and advantages, and other features and attendant advantages of this disclosure, will be readily apparent from the following Detailed Description of illustrated examples and representative modes for carrying out the disclosure when taken in connection with the accompanying drawings and the appended claims. Moreover, this disclosure expressly includes any and all combinations and subcombinations of the elements and features presented above and below.

### BRIEF DESCRIPTION OF THE DRAWINGS

FIG. 1 is a schematic diagram illustrating a representative generative-AI computational system with a trained LLM framework that uses linguistic intuitive manual prompting techniques for enhanced content creation in accord with aspects of the present disclosure.

FIG. 2 is a schematic diagram illustrating a representative layered system architecture of a generative-AI system showing a Core Platform Layer, a User Interface Layer, an Intelligence Layer, and a Data & Knowledge layer.

FIG. 3 is a flowchart illustrating a representative generative-AI system control protocol for embedded linguistic intuitive manual prompting techniques for enhanced content creation, which may correspond to non-transient, memory-stored instructions that are executable by a resident or remote microprocessor, control module, programmable logic circuit, central controller, or other integrated circuit device or network of processors/controllers/modules/circuits/devices (collectively “controller”) in accord with aspects of the present disclosure.

The present disclosure is amenable to various modifications and alternative forms, and some representative embodiments of the disclosure are shown by way of example in the drawings and will be described in detail herein. It should be understood, however, that the novel aspects of this disclosure are not limited to the particular forms illustrated in the above-enumerated drawings. Rather, this disclosure covers all modifications, equivalents, combinations, permutations, groupings, and alternatives falling within the scope of this disclosure as encompassed, for example, by the appended claims.

### DETAILED DESCRIPTION

This disclosure is susceptible of embodiment in many different forms. Representative embodiments of the disclosure are shown in the drawings and will herein be described in detail with the understanding that these embodiments are provided as an exemplification of the disclosed principles, not limitations of the broad aspects of the disclosure. To that extent, elements and limitations that are described, for example, in the Abstract, Introduction, Summary, Brief Description of the Drawings, and Detailed Description sections, but not explicitly set forth in the claims, should not be incorporated into the claims, singly or collectively, by implication, inference or otherwise. Moreover, recitation of “first”, “second”, “third”, etc., in the specification or claims is not per se used to establish a serial or numerical limitation; unless specifically stated otherwise, these designations may be used for ease of reference to similar features in the specification and drawings and to demarcate between similar elements in the claims.

For purposes of this disclosure, unless specifically disclaimed: the singular includes the plural and vice versa (e.g., indefinite articles “a” and “an” should generally be construed as meaning “one or more”); the words “and” and “or” shall be both conjunctive and disjunctive; the words “any” and “all” shall both mean “any and all”; and the words “including,” “containing,” “comprising,” “having,” and the like, shall each mean “including without limitation.” Moreover, words of approximation, such as “about,” “almost,” “substantially,” “generally,” “approximately,” and the like, may each be used herein to denote “at, near, or nearly at,” or “within 0-5% of,” or “the same or practically the same as,” or any logical combination thereof, for example.

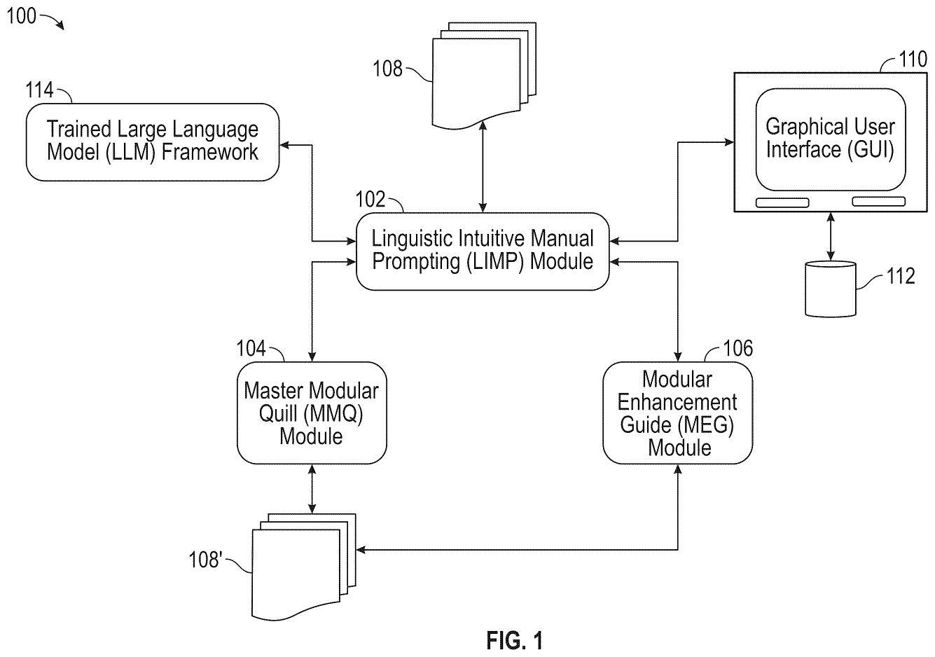

Referring now to the drawings, wherein like reference numbers refer to like features throughout the several views, there is shown in FIG. 1 a representative generative-AI computational system 100 with a trained LLM framework 114 that uses linguistic intuitive manual prompting techniques for enhanced content creation. The illustrated generative-AI computational system 100—also referred to herein as “generative AI system” or “system” for short—is merely an exemplary application with which novel aspects of this disclosure may be practiced. In the same vein, incorporation of the present concepts into a multimodal, supervised machine learning LLM should also be appreciated as a non-limiting application of disclosed features. As such, it will be understood that novel aspects of this disclosure may be integrated into a variety of different generative AI system architectures and may be employed by any logically relevant type of language model. Moreover, only select components of the computational system 100 are shown and described in detail below. Nevertheless, the generative AI systems discussed herein may include numerous additional and alternative features, and other available peripheral hardware, for carrying out the various methods and functions of this disclosure.

For enhanced content creation, the trained LLM framework 114 may coordinate user prompt structuring with a Linguistic Intuitive Manual Prompting (LIMP) component or module 102 that is interoperable with a Master Modular Quill (MMQ) component or module 104 and a Modular Enhancement Guide (MEG) component or module 106. The LIMP, MMQ, and MEG components 102, 104, 106 may collectively provide, for example, a structured approach to complex documentation for the collaborative cocreation of content. Operating as a uniquely structured, modular, and adaptive framework for large language model interaction, the generative-AI computational system 100 architecture may be engineered to maximize user engagement while adhering to accompanying compliance standards. The LIMP component 102, for example, may act as a foundational module within an intelligence layer of the system architecture that provides linguistic and structural guidelines that serve as the basis for most or all system interactions. The system's linguistic structure—the natural language processing subroutines—may be divided into self-contained component modules 108 that users can independently activate. This flexibility may allow for rapid adjustments to the individual modules 108 without affecting the overall system 100, thus enabling the ability to deliver a tailored and user-centered experience. Moreover, the LIMP component 102 may enable users to engage with the LLM system 100 more intuitively without requiring specialized prompts or engineering skills, thereby making AI interaction more accessible and efficient.

With continuing reference to FIG. 1, the Master Modular Quill component 104 may interact with a user interface layer to assemble the LIMP component modules 108 into a functional “Quill” format (represented by reformatted modules 108′) that allows users to interact with the system 100 in a seamless and flexible way. The MMQ component 104 may organize these reformatted modules 108′ into a coherent format that allows for customizable user engagement. Compliance protocols may be embedded within each MMQ module 108′ to ensure that all operations within the generative-AI computational system 100 adhere to regulatory standards and meet established guidelines. The MMQ 104 provides adaptive configuration of the system 100 that enables individual users to switch, adjust, or customize individual modules 108′ in real-time. Doing so may expand the system's 100 usability across multiple applications, such as education and compliance.

The Modular Enhancement Guide component 106 may act as a dynamic module within the intelligence layer that enables real-time updates and compliance adaptations across the system's various quills (e.g., logging library software tool, writing and grammar software tool, word processing software tool, etc.). The MEG component 106 may help to ensure that each quill remains compliant and up-to-date, regardless of changing regulatory or user-driven factors. For instance, the MEG component 106 may continuously monitor for regulatory changes and feedback, updating individual modules 108′ within the MMQ 104, e.g., to maintain consistency and functionality. The MEG 106 may allow the system 100 to scale efficiently, for example, by keeping available user interfaces relevant and compliant. Moreover, the MEG component 106 may operate as a continuous update mechanism that allows the system 100 to be a sustainable tool that evolves with both legal requirements and user feedback, making it a “living system.”

Initiation of the generative-AI system 100 may begin with setup of the LIMP component 102, which may include establishing a set of linguistic and structural system parameters as well as setting a foundational stage for a designated quill or group of quills. A user may initiate and complete this process through a series of intuitive prompts designed to engage the LLM in a role-based capacity, e.g., to ensure optimal interaction and minimal setup complexity. The MMQ component 104 may evaluate and assemble the linguistic modules from the LIMP 102 into a coherent, functional quill format that may be configured to meet a set of specific user needs. The MMQ component 104 may also enable a range of module combinations in order to support different applications while providing flexibility and ensuring each quill meets core functionality standards. This step may enable users to tailor one or more of the system quills to select tasks without needing specialized skills in prompt engineering.

As used herein, the term “quill” may be defined to mean a domain-specific or domain-general reasoning schema encoded as a structured set of modular operations, instructional scaffolds, task phases, rubric expectations, and/or interaction patterns. Quills are typically not user-authored templates nor user-facing scripts; rather, quills may be internal knowledge objects that the system retrieves or synthesizes based on a user's input domain. A quill may provide the procedural and cognitive structure for a given task, such as elementary writing, historical analysis, syllabus development, embroidery instruction, doctoral dissertation work, etc. A quill may inform the LIMP-MMQ-MEG pipeline by supplying contextual expectations, reasoning phases, and structural rubrics. During operation, quills may be retrieved automatically from repositories (e.g., Pinecone or internal data stores). When no domain-specific quill exists, the system may use general knowledge sources and structured components extracted by LIMP to synthesize a new reasoning schema that conforms to the quill format. For at least some embodiments, users do not directly interact with quills; instead, the system internalizes the quill structure and uses it to drive reciprocal questioning, structured reasoning, and task completion guidance.

Upon completion of LIMP setup, the MEG component 106 may act as an adaptive module within the intelligence layer that enables the system 100 to respond dynamically to regulatory changes, user feedback, system parameter changes, framework updates, etc. By way of non-limiting example, the MEG 106 may continuously monitor external factors and automatically adjust, in real-time, the MMQ's reformatted modules 108′ as needed to maintain regulatory compliance and relevance. Doing so helps to ensure that each system 100 quill is aligned with current standards and ensures the generative-AI system 100 remains agile and scalable. The system 100 is able to generate language prompts (e.g., English text) that may be crafted in a modular series, where the output of a previous module is the input of a subsequent module in the series. Manual linguistic prompting at interval in conversation with an LLM may allow for circumvention of short-term memory and contextual holdings from output to output.

The generative-AI system 100 of FIG. 1 may operate as a robust and adaptive system for interacting with large language models to enhance user engagement, accuracy, and personalization. The system 100 may help to achieve meaningful, tailored outputs from LLMs, especially for users who do not have technical expertise in prompt engineering. Moreover, the system 100 may enable more intuitive and guided interactions with LLMs through a structured, modular approach that adapts dynamically to user needs across various applications and industries. The Master Modular Quill may act as a foundational guide that helps users frame their requests in a way that aligns with an LLM's optimal processing capabilities; this helps to ensure that system outputs are relevant, precise, and easily adaptable across different contexts. The Modular Enhancement Guide may act as a flexible layer within the system that allows for targeted adjustments based on user feedback, changing regulatory standards, or updates in LLM functionality. The MEG may enable the system to evolve dynamically while maintaining high standards of relevance and compliance.

The Master Modular Quill component may provide a step-by-step structure for users to interact with an LLM in a clear and purposeful manner. The MMQ component may output a sequence of modular prompts along with any attendant guidelines that can be adapted based on a desired outcome, a user's level of expertise, associated industry requirements, etc. The MMQ may be designed to ensure consistency, clarity, and relevance across different user prompts by breaking down complex interactions into manageable, repeatable steps. The MMQ may divide complex prompts into smaller, intuitive modules that allow users to construct detailed requests without needing advanced knowledge of how to craft natural language prompts, how to iteratively refine prompts for improved accuracy and effectiveness, and how to prime the LLM output. If desired, the MMQ may customize each module according to a defined set of needs specific to a user and/or an industry. In this instance, the MMQ may offer coherent instructions and logical suggestions for each step to reduce ambiguity and improve the user experience. During a user session with an LLM-based, generative-AI system, the MMQ component may commence by guiding a user through an initial setup phase where the system and user collaboratively define the purpose, tone, parameters, and audience of a desired output. The MMQ may then generate modular prompts that may be arranged or modified depending on a user-specific context to help ensure highly specific responses from the LLM.

As an interoperable component with the MMQ, the Modular Enhancement Guide may serve as a system-automated yet customizable “enhancement” module within the intelligence layer that refines and adapts the MMQ based on user-derived data, government regulations and restrictions, and/or updates in LLM functionality. The MEG may provide real-time adaptation by updating user prompts and linguistic modules in response to end-user feedback and insights. Adding MEG functionality to the MMQ component may enable users to achieve greater customization by tailoring the LLM system to meet a user's specific requirements without altering the foundational structure of the system. To this end, the MEG may be embodied as a software component overlay on the MMQ to provide additional guidance and enhancements to the initial prompt structure. For instance, if a new regulatory update affects data privacy standards, the MEG may automatically incorporate specific compliance language or instructions directly into the MMQ to ensure that outputs are aligned with these standards.

For system initialization, a user may start by first engaging with the MMQ, which guides the user through a series of setup prompts that is presented in a structured and purpose-driven form, e.g., to define a user intent and desired outcome. These inputs may help to define the purpose of the interaction, setting a foundation for the structured prompt generation. For contextual customization, the MEG may then be applied to fine-tune the MMQ for specific regulatory standards, user feedback, or advanced customization requirements. For execution and feedback, the structured prompts generated by the MMQ and enhanced by the MEG may be presented to the user; user responses are them submitted to the LLM. Through iterative feedback, the prompt structure may be continually refined and adapted for a particular user or group of users.

In one representative use-case scenario, an educator may use the MMQ to create a lesson plan with instructional materials tailored to different grade levels. The MEG may add a layer of regulatory compliance to ensure that the contents of the lesson plan and attendant materials adhere to educational standards like the NAEYC (National Association for the Education of Young Children). In another representative use-case scenario, a healthcare practitioner may use the MMQ to create a patient interaction script along with a documentation workflow. For this application, MEG may incorporate language that is compliant with the Health Insurance Portability and Accountability Act of 1996 (HIPAA) to ensure patient data privacy while maintaining the original structure of the prompts.

Guided prompt creation may be provided by the MMQ, which generates a sequence of user instructions through modular steps to build out an appropriate prompt or series of prompts. Each module may represent a specific aspect of the interaction, such as question framing, data presentation, LLM query parameters, context settings, etc. The MMQ may also enable user customization by allowing a user to selectively rearrange and modify individual modules to suit the complexity or simplicity needed for a particular interaction. By way of example, and not limitation, an educator may interact with an LLM to cocreate a lesson plan by first structuring an “Objective” module to set a desired learning goal, followed by a module for “Instructional Steps” and a module for “Evaluation Criteria.” Within each module, the MMQ may provide tips, examples, and suggestions designed to assist users with constructing precise prompts. MEG may enable users to add context-specific layers to each prompt, such as regulatory compliance, brand-specific language, or industry standards.

Once a prompt is finalized by a user through the MMQ and, if applicable, refined by MEG, the user or system may manually/automatically submit the structured input to the LLM. Using the LLM's output, the prompts may be iteratively refined by adjusting the linguistic modules within the MMQ or applying further MEG enhancements. The structured and refined outputs from the LLM may be presented to the user, aligning with the user-specific purpose defined at the beginning of the process. An educational output, for example, may include a fully developed lesson plan for a specific topic (e.g., trigonometry) for a designated group (e.g., 9^{th}-grade math students), while a business output may include a structured customer response (e.g., detailed reply to a request for proposal (RFP)) or a marketing strategy (e.g., long-term vision outlining business' value proposition to a customer).

Users may document and store their modular prompt structures for future use and, if desired, replicate the modular prompt structures with slight adjustments for other projects. The generative-AI computational system 100 of FIG. 1, for example, may include a graphical user interface (GUI) 110 through which a user interacts with the LIMP 102, MMQ 104, and MEG 106 and accesses a resident or remote database 112 that may contain a library of modular prompts that can be referenced and reused by the user. Structured, reusable prompts may allow users to develop templates for recurring tasks with a concomitant saving in time and costs on future interactions while efficiently scaling up their LLM usage. In other words, a system embedded feature enables users to save, replicate, and modify modular prompts to create a scalable library of effective prompts.

Attendant benefits for at least some of the disclosed concepts include a trained LLM framework that helps to eliminate barriers to effective LLM utilization for diverse user bases. Using a structured linguistic prompt system may help to obviate user-borne challenges with prompt formulation, leading to more consistent, effective, and specific user responses. Providing an easy-to-follow prompt framework may help to empower heterogeneous user types to engage with LLMs, making advanced language models accessible and valuable across assorted sectors. This approach may reduce or outright eliminate the need for specialized prompt training, democratizing the benefits of AI-driven language tools. Continual user feedback and iterative improvement may provide a “test-and-learn” environment that is more efficient than current systems, which often require full prompt rewrites for refinements. In contrast to conventional free-form prompting, where variability in language often leads to inconsistent outputs, using pre-structured modules and templates may promote consistency in responses across various tasks and users.

Unlike commercially available prompt engineering tools, which may provide users with static prompt structures and templates for limited tasks, the interoperable modular structure provided by the illustrated framework along with the customizable enhancement guide provided by the MEG component may provision real-time adaptation to context, compliance requirements, and user-specific needs. In contrast to customized instruction features offered by some LLM architectures, which may allow users to input unique instructions or use memory-stored user preferences, the MMQ structure may provision a step-by-step, modular approach that breaks down complex queries, ensuring that each aspect of a task is well-defined and consistent. Additionally, the MEG component may enable context-specific adjustments that can be layered without needing to rewrite prompts or rely on memory-stored data. Unlike industry-specific LLM models, which are built and trained and, thus, limited to a particular application, the disclosed LLM framework is industry-agnostic, designed to adapt to assorted applications via customizable modular prompts.

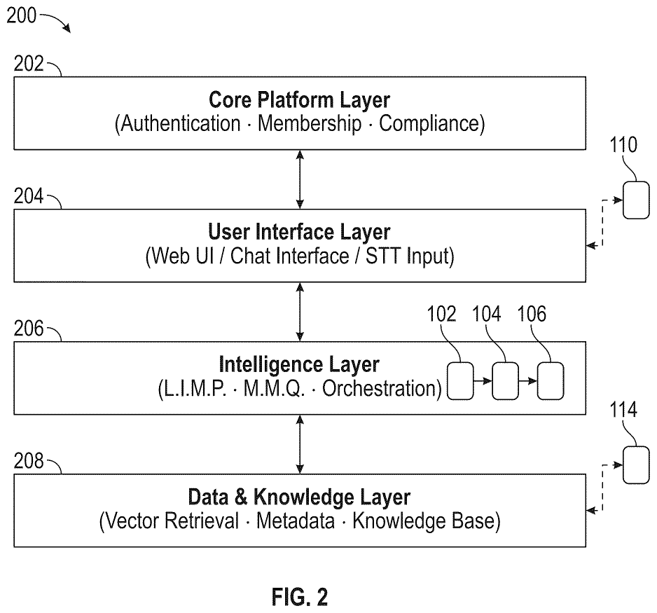

Turning next to FIG. 2, there is shown a representative layered system architecture 200 of a generative-AI system for converting free-form, natural language inputs into structured reasoning steps, sequentially executing those steps, and recursively refining the language model output. Analogous to the generative-AI computational system 100 of FIG. 1, the layered system architecture 200 of FIG. 2 contains three primary reasoning modules: (1) the linguistic-structuring LIMP module 102, (2) the modular-reasoning orchestration MMQ module 104, and (3) the recursive-refinement MEG module 106. In FIG. 2, these three interoperable modules 102, 104, 106 are embedded within a single intermediate software layer and arranged sequentially in a deterministic multistage pipeline. The layered system architecture 200 may be typified by: (1) a Core Platform (CP) Execution Layer 202 that provisions model interface, container runtime, and system scheduling functionalities; (2) a User Interface (UI) Layer 204 through which users interact with the other system layers; (3) an Intelligence Orchestration (IO) Layer 206 that provisions the LIMP, MMQ, and MEG modules; and (4) a Data & Knowledge (D&K) Layer 208 that provisions retrieval engines, searchable vector databases, external API connectors, structured documents, and tool invocation features. The illustrated architecture 200 supports scalable, deterministic workflows for multi-step reasoning tasks.

Core Platform Layer 202 may be a foundational execution layer that governs model runtime for loading, running, and managing LLM operations, along with providing an execution engine tool for data processing, query execution, and workflow automation. In addition to runtime and execution engine functionality, the Core Platform Layer 202 may handle all system scheduling and containerization of the LLM (e.g., isolation of the model into a portable, secured environment). The Core Platform Layer 202 may also handle user authentication and access, user session management, and system compliance reinforcement. This CP Layer 202 may be implementation-agnostic to support deployment of the layered system architecture 200 across cloud, on-premise, and hybrid environments.

With continuing reference to FIG. 2, the User Interface Layer 204 is an interactive and adaptable software tool that is designed to make interaction with the layered system architecture 200 intuitive, flexible, and efficient. By way of example, and not limitation, the UI Layer 204 may enable front-end interaction, including a web interface, a chat interface, a speech-to-text (S2T) input, and message formatting and transmission. For instance, UI Layer 204 may be presented to the user in the form of a multimodal chat-based interface and prompt editor on the GUI 110 of the user's personal computing device to enable free-form text input and streaming model responses. Most importantly, the UI Layer 204 may function to capture raw user inputs for downstream processing by the LIMP, MMQ, and MEG modules 102, 104, 106.

The Intelligence Orchestration Layer 206 may be embodied as an orchestration controller for governing, coordinating, and monitoring the LIMP, MMQ, and MEG modules 102, 104, 106. In addition to pipeline module control, the IO Layer 206 may also provision the control and logic used to govern and optimize the large language model and how it interacts with data, tools, users, and other models within a desired application or workflow. In accord with the illustrated examples, the IO Layer 206 may coordinate the automated reasoning pipeline by directing the activities of the LIMP, MMQ, and MEG modules, and may maintain the quill-based structure of reasoning (e.g., it does not impose policies or alter intent). When a domain-specific quill exists (e.g., elementary narrative quill, civics argumentation quill, dissertation-writing quill, etc.), the IO Layer 206 may retrieves a quill from an internal store or a set of vector stores and uses its schema to guide reasoning-plan assembly. When no domain-specific quill exists—which is typical to highly specialized tasks, such as embroidery—the IO Layer 206 may produce a structurally valid reasoning chain by: (i) using L.I.M.P. to extract structured components; (ii) querying general knowledge sources; and (iii) directing M.M.Q. to synthesize a new reasoning plan consistent with the quill schema. The user may be kept unaware of this process; they simply answer reciprocal questions. The IO Layer 206 may ensure domain-agnostic reasoning consistency by maintaining the quill-based structure of thought.

To effect linguistic preprocessing, the LIMP module 102 may receive one or more free-form, natural-language user inputs and prepare each input for modular reasoning. According to the illustrated example, the LIMP module 102 may perform:
1. prompt normalization-transforming a user's raw, free-form input into a structured and formatted prompt so the LLM is able to interpret the prompt accurately and consistently;
2. part-of-speech (POS) tagging-assigning a grammatical category (e.g., noun, verb, adjective, etc.) to each word in the user prompt;
3. sentence segmentation-dividing a block of text into individual sentences so the model and surrounding system can effectively interpret and process the text;
4. intent extraction-deriving the semantic meaning of a query and classifying it into a predefined category of intent;
5. query classification-analyzing the meaning and intent of the user's input to categorize it into a predefined action type (e.g., question vs. command vs. statement vs. hypothesis); and
6. identification of reasoning sub-tasks-breaking down a user's request into smaller, logically distinct components that the orchestration layer and model can address to produce a proper and coherent response.
   The output of LIMP may be a structured representation that contains discrete prompt components, each of which corresponds to a potential reasoning action.

After linguistic preprocessing and structural decomposition of the user input, the MMQ module 104 may construct a reasoning plan by sequencing and assembling the structured components into a modular reasoning pathway. MMQ module 104 of FIG. 2, for example, may access a library of predefined modular operations (e.g., stored within system database 112) to select therefrom a set of modular reasoning operations. An example library of modular reasoning operations available to the MMQ module may include: Define, Compare, Enumerate, Outline, Summarize, Solve, and Analyze. Each modular reasoning operation may correspond to one or more predefined templates and one or more transformations. Once selected, MMQ 104 may combine the operations into a sequence optimized for a desired task associated with the user prompt. In this example, the MMQ module 104 may determine which reasoning modules to apply, sequence the chosen modular steps, inject domain-specific instructions (e.g., specialized directives and select training data), and create a composite structured prompt that contains sequenced steps and structured instructions with associated system parameters. The MMQ 104 may select and assemble operations into reasoning plans based on the LIMP structured output. Output from the MMQ 104 may include a fully assembled reasoning plan that prescribes the operations to be executed by the language model. Optional metadata, such as operation dependencies and input requirements, may guide MMQ sequencing and MEG refinement.

In accord with the illustrated example, MMQ module 104 is typically not a user-configurable template engine; rather, MMQ may be a schema-based reasoning compiler that constructs modular reasoning plans using the structured components generated by LIMP module 102. Upon determining that a relevant quill with representative reasoning schema exists, the system may responsively retrieve it; upon determining that a relevant quill does not exist, MMQ may responsively synthesize a new reasoning plan using general knowledge while preserving a preset quill structure. MMQ may select modular reasoning operations (DEFINE, OUTLINE, SYNTHESIZE, CRITIQUE, ENUMERATE, ALIGN, SIMPLIFY, etc.) based on the quill schema and sequence them into a coherent, domain-appropriate reasoning pathway. Sequencing may be guided by a set of rubric criteria (e.g., argumentative clarity for dissertations, conceptual ordering for elementary tasks, etc); MMQ constructs an internal reasoning blueprint—not generated text—that is subsequently refined by MEG.

After MMQ sequencing of the modular reasoning steps, the MEG module 106 may receive intermediate model outputs during execution by the LLM and recursively refine the reasoning pathway based on real-time evaluation of these outputs and structured feedback loops. Refinement may include iteratively adjusting modular steps, reordering operations, amending instructions, adding clarifying constraints, and removing redundant steps. Refinement continues until a preset stability, convergence, or confidence threshold is reached. A final refined pathway is generated by the MEG module 106 and then passed to a language-model inference engine within the D&K Layer 208. A non-limiting example of recursive refinement includes:
1. a user asks: “Help me develop the argument chapter for my doctoral dissertation in environmental economics.”;
2. L.I.M.P. extracts structured components such as: {DEFINE: research problem}, {OUTLINE: argument structure}, {SYNTHESIZE: literature positions}, {CRITIQUE: assumptions}, {CONSTRUCT: intervention}, {ALIGN: methodology};
3. M.M.Q. assembles a reasoning plan in accordance with the Dissertation Quill schema;
4. M.E.G. First Pass: intermediate output may define the problem and outline the argument but omit a clear field intervention or methodological link;
5. MEG inserts new operations (e.g., IDENTIFY assumptions, EVALUATE theoretical lenses, ALIGN to methodology) and adjusts the sequence order;
6. M.E.G. Second Pass: new output now includes assumptions and theory but lacks contribution;
7. MEG inserts {CONTRIBUTE: theoretical or empirical novelty};
8. M.E.G. Third Pass: evaluates coherence against rubric criteria (intervention clarity, structural alignment, contribution) and concurrently corrects minor inconsistencies; and
9. Convergence: determines two successive refinements yield substantially the same reasoning structure (e.g., DEFINE→OUTLINE→SYNTHESIZE→CRITIQUE→IDENTIFY→EVALUATE→ALIGN→CONTRIBUTE), MEG terminates refinement.
   The refined plan is then executed by the LLM.

In tandem with recursive refinement to convergence, the Data and Knowledge Layer 208 may operate as an interface layer that provisions vector search engines, external APIs, retrieval-augmented inputs, and knowledge-based connectors. The vector search engine may be generally typified as a retrieval system that stores text data as high-dimensional numerical vectors—called embeddings—and uses a similarity search function to locate pieces of information most relevant to a user's query. The external API may be a software interface provided by a peripheral system or application that D&K Layer 208 calls over a network to request data or perform actions it is unable to perform on its own. In an example, the external API may be employed when the language model or orchestration layer needs information or capabilities beyond the model's internal knowledge, such as looking up real-time data, accessing databases, or interacting with third-party services. To generate retrieval-augmented inputs, D&K Layer 208 may contain or call-up a Retrieval Augmented Generation (RAG) logic component that enhances a user's query with relevant context retrieved from an external knowledge base before being sent to the LLM. The knowledge-based connectors may integrate external data sources and content repositories by performing an initial and recurring synchronization to index documents and metadata from the external source, searching the indexed content, and assigning connector to relevant information.

The D&K Layer 208 may perform retrieval operations, including vector search, semantic similarity ranking, domain filtering, API queries, etc., based on task relevance and not user identity. Retrieval may provide supplemental factual grounding for reasoning-plan construction and refinement. When a domain-specific quill exists, retrieval may augment the quill; when no quill exists, retrieval may support synthesizing a new reasoning plan that conforms to the quill schema. The D&K Layer 208 may help to enrich content but does not determine or alter the L.I.M.P.-M.M.Q.-M.E.G. reasoning sequence.

Along with providing vector search and external tool access, the D&K Layer 208 may also function as a Data Access Layer (DAL) that provides various retrieval options for locating and accessing specific data from an internal database or external storage system. For example, Layer 208 may perform:
1. semantic matching—comparing two pieces of text, such as a user query and a stored document, based on their meaning rather than their exact wording;
2. relevance scoring—assigning a numerical value that represents how well a piece of retrieved content from the stored document matches the meaning/intent expressed in the user's query;
3. domain filtering—isolating and selecting information based on a specific subject area or knowledge domain so that the model only considers content that is objectively relevant to the user's intent and context; and
4. task-weighted ranking—ordering selected information based on both its general semantic relevance and how well it supports the specific task the LLM is attempting to perform.
   D&K Layer 208 may facilitate factual grounding of the reasoning pathway without personalization or identity influence.

It is envisioned that the layered system architecture 200 may optionally invoke external tools or retrieval modules as steps within the reasoning pathway of the MMQ component 104. Moreover, tool results may be fed back into the MEG component 106 for further refinement. For integration with a large language model framework, the system architecture 200 may provide the refined reasoning plan to a language-model engine, which executes the instructions within the refined reasoning plan and returns a “final” model response. This may be implemented through any LLM provider or fully local inference environment, e.g., to improve deterministic reasoning regardless of the underlying model.

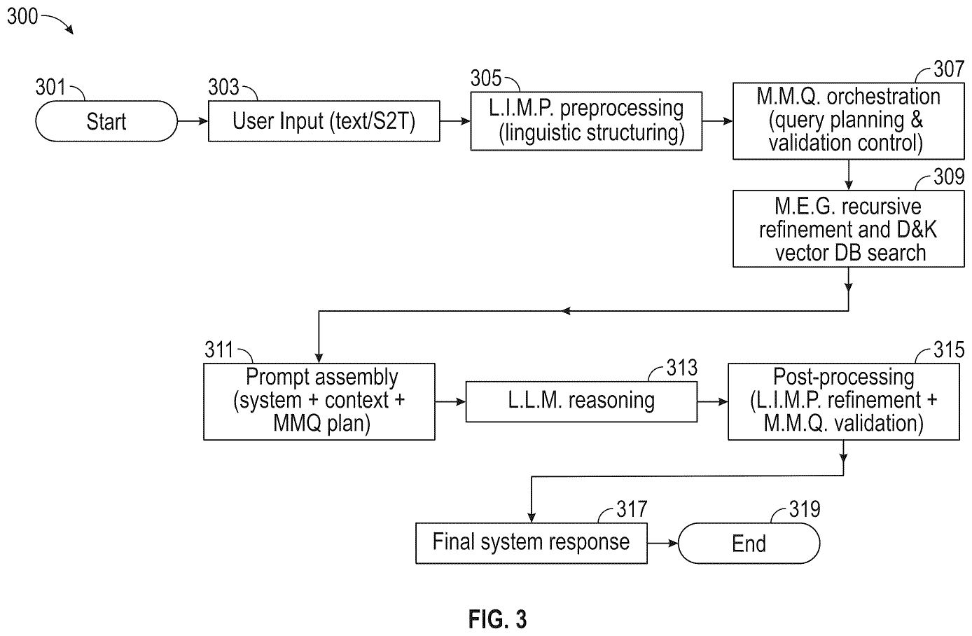

With reference next to the flowchart of FIG. 3, an improved method or control protocol for governing operation of a generative-AI system, such as AI computational system 100 of FIG. 1, to execute linguistic intuitive manual prompting techniques for enhanced content creation of a language model, such as a multimodal SML-LLM 114 of FIG. 2, is generally shown at 300 in accordance with aspects of the present disclosure. Some or all of the operations illustrated in FIG. 3 and described in further detail below may be representative of an algorithm that corresponds to non-transitory, processor-executable instructions that may be stored, for example, in main or auxiliary or remote memory (e.g., system database 112 of FIG. 1). These instructions may be executed by a resident or remote microprocessor, control module, programmable logic circuit (PLC), central controller, integrated circuit (IC) device, or network of processors/controllers/modules/devices/etc. (e.g., layered system architecture 200 of FIG. 2) to perform any or all of the above and below described functions associated with the disclosed concepts. It should be recognized that the order of execution of the illustrated operation blocks may be changed, additional operation blocks may be added, and some of the herein described operations may be modified, combined, or eliminated.

Method 300 begins at START terminal block 301 of FIG. 3 with memory-stored, computer-readable instructions for initializing a modular artificial-intelligence reasoning protocol using a deterministic, multi-module pipeline. Once initialized, method 300 advances to USER INPUT data input block 303 to receive one or more user-generated input prompts. For example, User Interface Layer 204 of the generative AI system architecture 200 of FIG. 2 may communicate with a personal computing device of a user to receive therefrom a text-based user input that contains a natural language prompt. The user input may take on innumerable formats, such as manually typed prompts, copy-and-pasted prompts, and transcribed speech-to-text (S2T) prompts that contain unstructured, natural-language text.

After receiving a user input, method 300 executes L.I.M.P. PREPROCESSING subroutine 305 to segment the natural language contents within the user's prompt into structured components through “linguistic structuring”. By way of example, and not limitation, LIMP component 102 within IO Layer 206 of FIG. 2 preprocesses the text-based user input to transform the free-form natural language prompt to a set of structured prompt components that can be orchestrated by the MMQ component 104. Linguistic structing may include:
1. tokenization—converting raw text (letters, words, punctuation) into basic “token” units that the model uses to understand and generate language;
2. segmentation (sentence, clause)—breaking the user's prompt into smaller, logically distinct units, such as sentences, clauses, tasks, etc., so the model can interpret and process each part more effectively;
3. clause decomposition—breaking a complex sentence into individual clauses, each of which represents a discrete action, condition, or idea, to ensure the model can understand and execute the request more accurately;
4. intent detection—deriving the underlying purpose behind a user's prompt so the orchestration layer can determine what the user is trying to accomplish;
5. subtask extraction—identifying and isolating smaller, discrete steps embedded within a user's prompt so the model can address each part systematically;
6. linguistic normalization—transforming a user's raw input into a clean, standardized, and linguistically consistent format so the model can interpret it more accurately (e.g., tense, pronoun consistency, removal of filler); and
7. noise reduction—removing irrelevant and low-information content from a user's prompt so the language model can focus on the relevant elements that matter for completing the requisite task.
   The output of LIMP preprocessing is a structured representation of the user's request broken down into actionable reasoning elements, i.e., “prompt components”.

Method 300 transitions from subroutine 305 to M.M.Q. ORCHESTRATION subroutine 307 to construct and validate a reasoning plan using a series of modular assembly operations. With reference again to the example of FIG. 2, the MMQ component 104 within Intelligence Orchestration Layer 206 accesses a library of predefined modular operations and selects therefrom a set of modular reasoning operations for a desired task associated with the user's natural language prompt. In other words, the modular-assembly process may include selection and sequencing of modular reasoning operations from a library of available reasoning steps (e.g., “Define”, “Compare”, “Summarize”, “Solve”, etc.). Upon selection of the reasoning operations, MMQ orchestration then performs query planning by mapping the structured prompt components to these reasoning operations and concurrently orders the operations into a coherent multi-step plan. For validation control, the MMQ component 104 may check ordering constraints, remove redundant or contradictory steps, ensure dependencies are satisfied, and verify completeness of the reasoning plan. In essence, the MMQ builds a reasoning blueprint; it does not generate LLM response text.

A non-limiting example of the MMQ selecting and sequencing modular reasoning operations includes:
1. User prompt: “Create a lesson plan on the water cycle for fifth graders.”;
2. MMQ selection and sequencing:
   a. Identify Task Type: Instructional content generation.
   b. Select Relevant Operations:
      i. Define
      ii. Outline
      iii. Sequence
      iv. Summarize;
   c. Sequence Reasoning Steps:
      i. Step 1: define key terms (evaporation, condensation, precipitation)
      ii. Step 2: outline lesson objectives.
      iii. Step 3: sequence instructional activities.
      iv. Step 4: provide summary assessment items; and
3. MMQ then produces a composite plan that MEG refines.

Advancing to M.E.G. REFINEMENT LOOP subroutine 309, method 300 performs recursive refinement of the reasoning plan and the intermediate outputs from the LLM that are generated through iterative execution of the refined reasoning plans. For example, the MEG component 106 may iteratively refine the set of reasoning steps through repeated, self-referential steps—with each new version building on the last—to generate a refined reasoning plan. The MEG component 106 may evaluate each “intermediate” model output, adjust the modular steps based on this evaluation, and converge on a stable reasoning pathway. An example of the MEG performing recursive refinement to reach convergence includes:
1. a user asks for a compliance-safe email template for healthcare practitioners;
2. MMQ produces steps: identify purpose, collect constraints, generate template structure;
3. LLM outputs a template but omits HIPAA-compliant phrasing around PHI handling;
4. MEG detects the omission, inserts a constraint step, and reissues the instruction;
5. LLM updates the output; and
6. MEG checks again to find full alignment.
   In this example, convergence is achieved when MEG sees no deviation between the refined reasoning plan and the LLM output.

In tandem with recursive refinement, a vector search engine within the D&K Layer 208 of FIG. 2 may perform one or more vector database (DB) searches to retrieve informational context data for the plan's reasoning steps based on a set of associated relevance and semantic criteria. Executing a vector DB search may include performing a task-based semantic weighting for each step in the set of reasoning steps. Semantic weighting may be typified as the manner in which the language model internally assigns different levels of importance to words, phrases, or concepts based on their meaning and relevance within a given context. The task-based semantic weighting may be weighted based on a semantic similarity to extracted subtask weight, a document relevance weight, a domain filtering weight, and/or a task-priority criteria weight. Semantic similarity may refer to a measure of how closely two pieces of text relate in meaning, regardless of the specific words that are used. In the context of task-based semantic weighting, document relevance may refer to how well a retrieved document supports a specific task an LLM is attempting to perform, e.g., taking into account both its semantic similarity to the user's prompt and additional task-specific criteria. Domain filtering may refer to the process of restricting retrieved documents or candidate contexts to a specific subject area that aligns with the task's requirements before applying task-weighted relevance scoring.

After recursive refinement of the reasoning plan and the model's intermediate outputs, method 300 proceeds to PROMPT ASSEMBLY subroutine 311 to assemble a “full” composite prompt that contains system, context, and MMQ plan data. Using the refined reasoning plan, for example, the MMQ component 104 of FIG. 2 may generate a composite prompt that contains a set of structured instructions with a set of associated system parameters and retrieved contextual data. Composite prompt assembly may optionally include retrieval/tool interactions, such as inputs to MMQ and/or MEG from external APIs, databases, or programmatic tools. In general, the system 200 produces a composite prompt by combining the reasoning plan created by MMQ, retrieved contextual information, and system-level formatting/structuring parameters. Doing so allows the LLM to execute a deterministic, multi-step reasoning path.

Method 300 also executes L.L.M. REASONING data output block 313, during which an LLM execution engine executes the initial and refined reasoning plans in order to produce initial/refined “intermediate” outputs. The structured reasoning plan-a composite prompt and execution plan produced through MMQ and refined by MEG—is fed into the LLM to develop an appropriate response to the user's initial prompt. By way of clarification, and not limitation, the language model does not generate a complete output independently; rather, the model executes a refined modular reasoning plan that incorporates user-provided content gathered through reciprocal questioning. Each transition in the quill schema may require a user response, ensuring originality and preventing plagiarism. For example, a user may submit a dissertation argument request; L.I.M.P. extracts structured components; M.M.Q. builds a Dissertation Quill-based plan; and M.E.G. refines it using rubric criteria (argument clarity, structural alignment, theoretical contribution). Before moving between modules, the system prompts the user with questions such as: (1) “State your central argument in your own words.”; (2) “Which assumptions are you challenging?”; and (3) “How does your methodology support your position?”. In this instance, the reasoning does proceed without user-generated intellectual content. The final composite prompt may then be executed by the LLM, producing text that reflects: (i) quill structure, (ii) modular reasoning operations, and (iii) user-supplied original content.

After the refined plan is sent to the LLM execution engine for iterative generation of intermediate system responses, method 300 transitions to L.I.M.P. POST-PROCESSING subroutine 315 to validate plan adherence and improve the clarity, coherence, and overall quality of language in a final model response without altering its core meaning. This refinement may include enhancing grammar, smoothing awkward phrasing, tightening structure, improving tone, resolving ambiguities, and aligning the text with stylistic or domain-specific conventions. For instance, the LIMP component 102 may refine linguistic clarity through grammar smoothing, conciseness, formatting, etc., while the MMQ component 104 validates that the final LLM output adheres to the requisite structure set forth in the reasoning plan. A final system response, be it natural-language text or a formal structured answer, is output to the user at FINAL SYSTEM RESPONSE data output block 317. Upon completion of some or all of the control operations presented in FIG. 3, method 300 may advance to END terminal block 319 and temporarily terminate or, optionally, may loop back to terminal block 301 and run in a continuous loop.

Traditional LLM systems typically generate responses using single-pass natural-language inputs. While this approach may enable fluent text generation, it provides limited control over the reasoning pathway. Disclosed generative-AI computational systems and control logic may overcome the deficiencies of existing systems by: (1) providing structure (e.g., inputs are formatted and consistent, eliminating the need for the model to infer the desired reasoning steps); (2) ensuring low output variance (e.g., small changes in phrasing do not significantly alter output quality); (3) using expanded multi-step reasoning (e.g., provide orchestrated modular decomposition that enable the reliable performance of complex tasks); (4) employing a standardized refinement loop (e.g., provide premediated or deterministic iterative prompting); and (5) incorporating enhanced auditability (e.g., provide a reproducible sequence of reasoning steps). In effect, disclosed systems may reliably transform free-form user inputs into structured modular reasoning plans, concomitantly apply recursive refinements, and consistently integrate with LLM execution engines.

Disclosed features may provide several advantages over existing frameworks for natural language processing and content generation, including:
1. deterministic modular reasoning: a pipeline that converts free-form natural language into structured reasoning sequences;
2. reduced output variance: modular decomposition and refinement loop to improve consistency across multiple inference runs;
3. increased transparency and auditability: a clear sequence of reasoning steps that may be inspected, repeated, or modified;
4. extensibility: modular operations allow new reasoning steps to be added without redesigning the system;
5. improved performance in complex tasks: recursive refinement ensures that intermediate reasoning errors do not propagate unchecked; and
6. compatibility with existing LLMs: platform can be integrated with any model or tool via API or orchestration interfaces.
   These improvements over conventional computational techniques render the system suitable for high-precision reasoning tasks in education, research, enterprise, and other software environments that may require predictable AI outputs.

Conventional LLMs primarily employ prompt engineering techniques to produce consistent results or expert-level results, requiring users to manually instruct the model with long, complex, and repetitive prompts. Non-limiting examples of these prompts may include:

“Act as an expert in _{——}_{——}.”
“Follow these 12 steps exactly.”
“Break the task down.”
“Refine your previous answer.”
“Analyze before responding.”
“Show your reasoning.”
“Use this tone.”
“Use this persona.”

This requires users to create their own prompt structure, which engenders a high skill barrier and generates unpredictable outputs. Users are also forced to re-specify identity/persona information, which the model forgets between turns, and provide step-by-step reasoning, which is inefficient and leads to frequent drift. Conventional prompt engineering also requires the user iterate manually, which is time-consuming and prone to error, and engineer “mega-prompts”, which are “fragile” and, thus, break easily with small changes.

In contrast to these existing methodologies, disclosed generative AI computational systems may replace prompt engineering with architecture engineering. By way of non-limiting example, a user may input a request to “help me explain the Moon to my child” or “strengthen my dissertation argument”; the system may then self-construct the entire reasoning pathway internally. For instance, the LIMP module may convert raw language into structured prompt components, e.g., removing the need to manually specify format/structure. The MMQ module may then select and sequence the modular reasoning steps, e.g., to eliminate “break this down, follow these steps” type prompts. Recursive refinement until convergence may be executed by the MEG module, e.g., to eliminate human-driven iterative re-prompting. For at least some implementations, disclosed architecture engineering (modular intelligence) techniques incorporate rules of a particular type that improve existing LLM process by shifting orchestration from user prompts to modular system designs, replacing heuristic prompting with deterministic multi-module reasoning, and introducing a standardized recursion engine.

Aspects of this disclosure may be implemented, in some embodiments, through a computer-executable program of instructions, such as program modules, generally referred to as software applications or application programs executed by any of a controller or the controller variations described herein. Software may include, in non-limiting examples, routines, programs, objects, components, and data structures that perform particular tasks or implement particular data types. The software may form an interface to allow a computer to react according to a source of input. The software may also cooperate with other code segments to initiate a variety of tasks in response to data received in conjunction with the source of the received data. The software may be stored on any of a variety of memory media, such as CD-ROM, magnetic disk, and semiconductor memory (e.g., various types of RAM or ROM).

Moreover, aspects of the present disclosure may be practiced with a variety of computer-system and computer-network configurations, including multiprocessor systems, microprocessor-based or programmable-consumer electronics, minicomputers, mainframe computers, and the like. In addition, aspects of the present disclosure may be practiced in distributed-computing environments where tasks are performed by resident and remote-processing devices that are linked through a communications network. In a distributed-computing environment, program modules may be located in both local and remote computer-storage media including memory storage devices. Aspects of the present disclosure may therefore be implemented in connection with various hardware, software, or a combination thereof, in a computer system or other processing system.

Any of the methods described herein may include machine readable instructions for execution by: (a) a processor, (b) a controller, and/or (c) any other suitable processing device. Any algorithm, software, control logic, protocol, or method disclosed herein may be embodied as software stored on a tangible medium such as, for example, a flash memory, a solid-state drive (SSD) memory, a hard-disk drive (HDD) memory, a CD-ROM, a digital versatile disk (DVD), or other memory devices. The entire algorithm, control logic, protocol, or method, and/or parts thereof, may alternatively be executed by a device other than a controller and/or embodied in firmware or dedicated hardware in an available manner (e.g., implemented by an application specific integrated circuit (ASIC), a programmable logic device (PLD), a field programmable logic device (FPLD), discrete logic, etc.). Further, although specific algorithms may be described with reference to flowcharts and/or workflow diagrams depicted herein, many other methods for implementing the example machine-readable instructions may alternatively be used.

Aspects of the present disclosure have been described in detail with reference to the illustrated embodiments; those skilled in the art will recognize, however, that many modifications may be made thereto without departing from the scope of the present disclosure. The present disclosure is not limited to the precise construction and compositions disclosed herein; any and all modifications, changes, and variations apparent from the foregoing descriptions are within the scope of the disclosure as defined by the appended claims. Moreover, the present concepts expressly include any and all combinations and subcombinations of the preceding elements and features.

What is claimed:

1. A method of operating a generative artificial intelligence (AI) system, the method comprising:
receiving, via a user interface layer of the generative AI system from a computing device of a user, a text-based user input containing a natural language prompt;
preprocessing, via a Linguistic Intuitive Manual Prompting (LIMP) component within an intelligence pipeline layer connected to the user interface layer, the text-based user input to transform the natural language prompt to a set of structured prompt components;
selecting, via a Master Modular Quill (MMQ) component within the intelligence pipeline layer of the generative AI system from a library of predefined modular operations, a set of modular reasoning operations for a desired task associated with the natural language prompt;
mapping, via the MMQ component, the set of structured prompt components to the set of modular reasoning operations to generate a set of reasoning steps;
performing, via a Modular Enhancement Guide (MEG) component, recursive refinement of the set of reasoning steps to generate a refined reasoning plan;
generating, via the MMQ component using the refined reasoning plan, a composite prompt containing a set of structured instructions with associated system parameters; and
executing, via a large-language model (LLM), the set of structured instructions with associated system parameters within the composite prompt to generate an LLM output.

2. The method of claim 1, further comprising sequencing, via the MMQ component, the set of reasoning steps to generate a sequenced set of reasoning steps prior to the MEG component performing the recursive refinement.

3. The method of claim 2, further comprising validating, via the MMQ component, the sequenced set of reasoning steps to remove therefrom any redundant or contradictory steps.

4. The method of claim 3, wherein validating the sequenced set of reasoning steps includes checking ordering constraints, ensure dependencies satisfied, and verify completeness of the reasoning plan.

5. The method of claim 1, further comprising executing, via a Data & Knowledge layer connected to the intelligence pipeline layer, a vector database search to retrieve informational context data for the set of reasoning steps based on associated relevance and semantic criteria.

6. The method of claim 5, wherein executing the vector database search includes performing a task-based semantic weighting for each step in the set of reasoning steps.

7. The method of claim 6, wherein the task-based semantic weighting is weighted based on a semantic similarity to extracted subtask weight, a document relevance weight, a domain filtering weight, and/or a task-priority criteria weight.

8. The method of claim 5, wherein retrieving the informational context data includes semantic matching, relevance scoring, and/or domain filtering.

9. The method of claim 1, wherein preprocessing the text-based user input includes tokenization, segmentation, and clause decomposition of the natural language prompt.

10. The method of claim 9, wherein preprocessing the text-based user input further includes intent detection, subtask extraction, and linguistic normalization of the natural language prompt.

11. The method of claim 1, further comprising refining, via the LIMP component of the generative AI system, a linguistic clarity of the LLM output executed by the LLM to generate a refined LLM output.

12. The method of claim 11, further comprising validating, via the MMQ component of the generative AI system, the refined LLM output to the refined reasoning plan to generate a final LLM output.

13. The method of claim 1, wherein the library of predefined modular operations includes an input types module, an output types module, a dependencies module, a constraints module, and an associated template module.

14. A non-transient, computer-readable medium storing instructions executable by a system controller of a generative artificial intelligence (AI) system, the instructions, when executed by the system controller, causing the generative AI system to perform operations comprising:
receiving, via a user interface layer of the generative AI system from a computing device of a user, a text-based user input containing a natural language prompt;
preprocessing, via a Linguistic Intuitive Manual Prompting (LIMP) component within an intelligence pipeline layer connected to the user interface layer, the text-based user input to transform the natural language prompt to a set of structured prompt components;
selecting, via a Master Modular Quill (MMQ) component within the intelligence pipeline layer of the generative AI system from a library of predefined modular operations, a set of modular reasoning operations for a desired task associated with the natural language prompt;
mapping, via the MMQ component, the set of structured prompt components to the set of modular reasoning operations to generate a set of reasoning steps;
performing, via a Modular Enhancement Guide (MEG) component within the intelligence pipeline layer, recursive refinement of the set of reasoning steps to generate a refined reasoning plan;
generating, via the MMQ component using the refined reasoning plan, a composite prompt containing a set of structured instructions with associated system parameters; and
executing, via a large-language model (LLM), the set of structured instructions with associated system parameters within the composite prompt to generate an LLM output.

15. A generative artificial intelligence (AI) system, comprising:
a user interface layer programmed to communicate with a computing device of a user and receive therefrom a text-based user input containing a natural language prompt;
an intelligence pipeline layer connected to the user interface layer and including:
a Linguistic Intuitive Manual Prompting (LIMP) component programmed to preprocess the text-based user input to transform the natural language prompt to a set of structured prompt components;
a Master Modular Quill (MMQ) component programmed to:
connect to a library of predefined modular operations and select therefrom a set of modular reasoning operations for a desired task associated with the natural language prompt, and
map the set of structured prompt components to the set of modular reasoning operations to generate a set of reasoning steps; and
a Modular Enhancement Guide (MEG) component programmed to perform recursive refinement of the set of reasoning steps to generate a refined reasoning plan, wherein the MMQ component is further programmed to generate a composite prompt containing a set of structured instructions with associated system parameters based on the refined reasoning plan; and
a large-language model (LLM) programmed to execute the set of structured instructions with associated system parameters within the composite prompt to generate an LLM output to the user.

16. The generative AI system of claim 15, wherein the MMQ component is further programmed to sequence the set of reasoning steps prior to performing the recursive refinement to generate a sequenced set of reasoning steps.

17. The generative AI system of claim 16, wherein the MMQ component is further programmed to validate the sequenced set of reasoning steps to remove therefrom any redundant or contradictory steps.

18. The generative AI system of claim 15, further comprising a Data & Knowledge layer connected to the intelligence pipeline layer and the LLM, the Data & Knowledge layer programmed to execute a vector database search to retrieve informational context data for the set of reasoning steps based on relevance and semantic criteria.

19. The generative AI system of claim 18, wherein executing the vector database search includes performing a task-based semantic weighting for each step in the set of reasoning steps, and wherein the task-based semantic weighting is weighted based on semantic similarity to extracted subtasks, document relevance, domain filtering, and/or task-priority criteria.

20. The generative AI system of claim 15, wherein the LIMP component is further programmed to refine a linguistic clarity of the LLM output executed by the LLM to generate a refined LLM output, and wherein the MMQ component if further programmed to validate the refined LLM output to the refined reasoning plan to generate a final LLM output.
